(19) United States
(12) Patent Application Publication
(10) Pub. No.: US 2008/0008382 A1
(43) Pub. Date: Jan. 10, 2008

(54) Automatic contrast correction device and automatic contrast correction method

(76) Inventor: Kenichi Matsushima, Chiba-shi (JP)

Correspondence Address: BRINKS HOFER GILSON & LIONE, P.O. BOX 10395, CHICAGO, IL, 60610, US

(21) Appl. No.: 11/824,296

(22) Filed: Jun. 29, 2007

(30) Foreign Application Priority Data
Jul. 3, 2006 (JP) JP2006-183428

(51) Int. Cl. G06K 9/00; G06K 9/40

(52) U.S. Cl. 382/167; 382/274

(57) ABSTRACT

Provided are an automatic contrast correction device and an automatic contrast correction method for a pictorial image constituted by luminance values for two-dimensionally arranged pixels capable of performing automatic correction to obtain a suitable contrast to human eyes corresponding to perception in a human brain. In order to obtain an optimized gradation characteristic for conversion, a frequency distribution is nonlinearly converted corresponding to a nonlinear perception of stimulus in a human brain to become flat. The conversion can generally keep an original characteristic of a picture having a good appearance to human eyes.

This application claims priority under 35 U.S.C. § 119 to Japanese Patent Application No. 2006-183428 filed Jul. 3, 2006, the entire content of which is hereby incorporated by reference.

### BACKGROUND OF THE INVENTION

1. Field of the Invention

The present invention relates to an automatic contrast correction device and an automatic contrast correction method capable of automatically correcting contrast of a pictorial image constituted by two-dimensionally arranged luminance information.

2. Description of the Related Arts

Up to now, a method for uniform distribution of image data over the entire range of gradation level to obtain a high-contrast image whose luminance range is most effectively used has been known as an automatic contrast correction method, which automatically corrects a contrast of a pictorial image constituted by two-dimensionally arranged luminance information (see, for example, JP 10-210323 A).

To be specific, in order to obtain a gradation characteristic in which a frequency distribution with respect to the number of pixels for each luminance value in an image becomes uniform, a method of accumulating the frequency distribution and normalizing the accumulated frequency distribution has been known. This principle will be described with reference to FIGS. 5A to 5C. FIG. 5A shows a frequency distribution of luminance values of an input image. FIG. 5B shows a gradation conversion characteristic obtained by performing accumulation and normalization on the frequency distribution shown in FIG. 5A. FIG. 5C shows a frequency distribution of luminance values of an image obtained by conversion of the input image related to FIG. 5A based on the gradation conversion characteristic shown in FIG. 5B. The frequency distribution of luminance values of an output image can thus be made flat by converting the luminance value with the gradation conversion characteristic obtained by accumulation and normalization of the frequency distribution for the luminance values of the input image.

The local frequency distribution of the luminance values of the output image can not be completely flat since the above-mentioned principle is conceptual and a frequency distribution has actually discrete values. The global frequency distribution is, however, substantially flat, a high-contrast output image can be obtained.

A conventional automatic contrast correction method for realization of the principle is now described with reference to FIG. 2. The number of pixels for each luminance value of an input image is counted by a frequency distribution counter 1 to obtain a frequency distribution. The obtained frequency distribution is converted into an accumulated value for each luminance value by an accumulation converter 2 and normalized thereby such that the maximum number for accumulation becomes a maximum output luminance value, thereby generating a gradation conversion characteristic. A gradation converter 3 converts the luminance values of the input image based on the gradation conversion characteristic generated in the accumulation converter 2. A controller 4 controls the entire status and timing. A high-contrast output image in which the global frequency distribution of the luminance values is substantially flat can be obtained.

An output image whose appearance is better than that of an input image can be obtained in many cases by correcting an image contrast with the above-mentioned conventional automatic contrast correction method. However, nonlinear reception of a stimulus by human eyes causes a problem that the obtained contrast is not necessarily best optimized to the eyes. In order to solve the problem, a method of developing the luminance of image data in a log scale to generate a frequency distribution is disclosed (see, for example, JP 2002-247364 A).

According to the conventional method of merely developing the luminance in the log scale to generate the frequency distribution, the frequency is, however, proportional to an area of an image having a certain luminance value. For example, when a region of approximately ⅕ of an image is dark in a backlight condition or the like as shown in FIG. 6A, the dark region becomes significantly dark since the influence of a bright region is strong. For example, when a region of approximately ⅘ of an image is dark in the backlight condition or the like as shown in FIG. 7A, a significantly bright image is obtained since the influence of a dark region is strong, deteriorating an original characteristic of a picture expressed by an original image. One of the reasons for absence in the optimized contrast for human eyes despite the flat frequency distribution of the luminance values as described above is that, in general, a strength of the stimulus from human eyes, which depends to a size of the region, is not simply proportional to the area of an image region due to the nonlinear reception of a stimulus by a human brain.

### SUMMARY OF THE INVENTION

The present invention has been made to solve the above-mentioned problems. Therefore, it is an object of the present invention to provide an automatic contrast correction device and an automatic contrast correction method capable of realizing automatic contrast correction in which a better contrast for human eyes is obtained corresponding to reception of a stimulus by human.

In order to solve the problem, according to the automatic contrast correction device and the automatic contrast correction method of the present invention, nonlinear converter is provided between frequency distribution counter and accumulation converter both of which are used for conventional automatic contrast correction.

That is, the number of pixels for each luminance value of an input image is counted by the frequency distribution counter to obtain a frequency distribution. The obtained frequency distribution is subjected to conversion corresponding to a stimulus applied to human eyes by the nonlinear converter to generate a nonlinear frequency distribution. The generated nonlinear frequency distribution is converted into an accumulated value for each luminance value by an accumulation converter and normalized thereby such that the maximum number for accumulation becomes a maximum output luminance value, thereby generating a gradation conversion characteristic. A gradation converter converts luminance values of the input image based on the gradation conversion characteristic generated in the accumulation converter. The entire status and timing are controlled by a controller to obtain an output image in which global nonlinear frequency distribution is substantially flat.

According to the automatic contrast correction device and the automatic contrast correction method of the present invention, the input image can be automatically converted into an image having a better contrast to human eyes corresponding to perception by a human brain.

### BRIEF DESCRIPTION OF THE DRAWINGS

In the accompanying drawings:

FIG. 1 is a block diagram showing an automatic contrast correction device according to an embodiment of the present invention;

FIG. 2 is a block diagram showing a conventional automatic contrast correction device;

FIG. 3 is a block diagram showing an example of an automatic color contrast correction device;

FIG. 4 is a block diagram showing another example of the automatic color contrast correction device;

FIGS. 5A to 5C are graphs showing a principle of automatic contrast correction by a flat frequency distribution to perform;

FIGS. 6A to 6D are graphs showing an example of an automatic contrast correction for a small dark region;

FIGS. 7A to 7D are graphs showing an example of an automatic contrast correction for a small bright region; and

FIGS. 8A to 8C show a gradation conversion characteristic for eliminating dark region.

### DESCRIPTION OF THE PREFERRED EMBODIMENTS

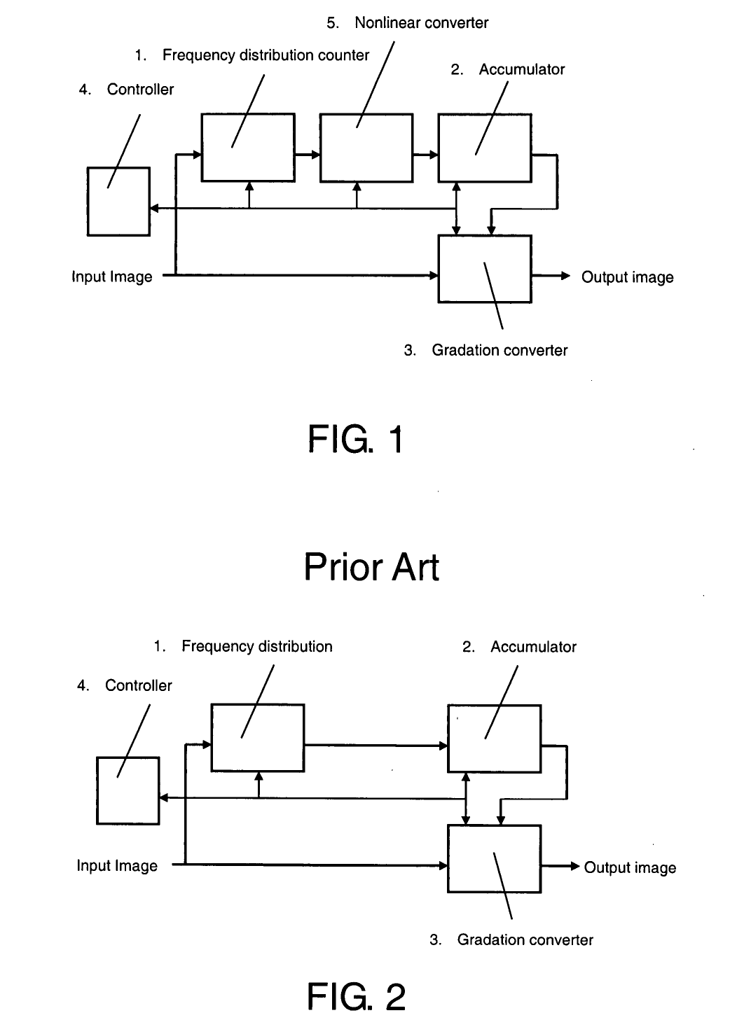

A preferred embodiment according to the present invention will be described with reference to FIG. 1.

An input image I(X, Y) represents image data for one screen normally expressed by a luminance value L of each pixel two-dimensionally arranged in a lateral direction and a longitudinal direction, such as a monochromatic pictorial image. The luminance value L is a digital value which only takes one of finite number of values. For example, the luminance value L takes any one of 256 values including 0, 1, 2, . . . , 255 in a case of eight bits. Conversion from a nonlinear characteristic to a linear characteristic in advance is desirable for the input image I(X, Y) having a nonlinear characteristic such as a gamma characteristic.

The input image I(X, Y) is sent to a frequency distribution counter 1 and the number of pixels for each luminance value L of the input image is counted to obtain a frequency distribution D(L),the number of pixels for each luminance value L. To be specific, the same number of memories D(L) as the number of values which can be taken by the luminance value L is prepared and initialized, and the input image I(X, Y) is scanned in a lateral direction X and a longitudinal direction Y, as expressed by Eq. 1, I(X, Y) for each pixel of the input image is substituted into the luminance value L and a value in the memory D(I(X, Y)) is incremented to obtain the frequency distribution D(L).
D(I(X,Y))=D(I(X,Y))+1 (Eq. 1)

Though the frequency distribution D(L) obtained here is the number of pixels of the input image I(X, Y) for each luminance value L, it can be also assumed that it corresponds to an area within the input image having each luminance value L.

The frequency distribution counter 1 normally obtains the frequency distribution D(L) of the entire image region. The frequency distribution D(L) of a specific region whose contrast is to be optimized may be obtained in an image. In order to change weight on each region, for example, addition of a weight value may be performed instead of the addition of one for normal increment.

The frequency distribution D(L) obtained by frequency distribution counter 1 is sent to a nonlinear converter 5 representing a feature of the present invention. In the nonlinear converter 5, the frequency distribution D(L) is converted corresponding to the characteristic of human brains to obtain a nonlinear frequency distribution H(L) in view of the fact that the light intensity as a whole is proportional to an area within an image having a certain luminance value and that the strength of a stimulus in a human brain has nonlinearity against the light intensity.

To be specific, it has been known that the manner of the reception of a stimulus in a human brain is more closely approximated by a power function or a logarithmic function rather than a linear function. For example, a CIELAB color space determined by CIE in 1976 is a uniform color space in which color difference perceived by human intentionally corresponds to a distance in the space and L* corresponding to luminance in the space is calculated by Eq. 2. Here, Y denotes one of three stimulus values and Yn denotes one of three stimulus values on a perfect diffuser plane corresponding to Y.
If (Y/Yn)>0.008856, L*=116×(Y/Yn)^{1/3}−16,
If (Y/Yn)≦0.008856, L*=903.29×(Y/Yn). (Eq. 2)

According to the present invention, it is considered that the area within the image corresponds to Y, one of the three stimulus values, since the area is proportional to the light intensity, and a stimulus in a human brain corresponds to L* expressing the luminance in the uniform color space. In other words, (frequency distribution D(L) divided by average frequency distribution) is used instead of (Y divided by Yn) and the nonlinear frequency distribution H(L) is used instead of L* in Eq. 2. Then, a nonlinear frequency is calculated from the frequency for each luminance value L to obtain the nonlinear frequency distribution H(L).

The average frequency distribution corresponding to Yn is used to eliminate the influence of the number of pixels and the number of levels of luminance value L and represents an average value over all the luminance values L of the frequency distribution D(L), which takes different values for each luminance value L. Here, the average frequency distribution is used for convenience and thus any other value capable of eliminating the influence of the number of pixels and the number of levels of luminance value L can be used. When an embodiment of the present invention is used in a limited range of the number of pixels and the number of levels of luminance value L, the presence of Yn can be ignored.

For simplified calculation, as shown in Eq. 3, the nonlinear frequency H is calculated from the frequency D for each luminance value L by taking the ¼th power to the ½nd power of a value obtained by dividing a frequency by an average frequency, thereby obtaining the nonlinear frequency distribution H(L), which is expected to have the same effect.
Nonlinear frequency=(frequency/average frequency)^{1/3} (Eq. 3)

A logarithmic function having a similar characteristic may be used instead of the ⅓rd power calculation or a table representing a characteristic of a stimulus in a human brain may be produced. The conversion is performed using the logarithmic function or the table to obtain the nonlinear frequency distribution H(L).

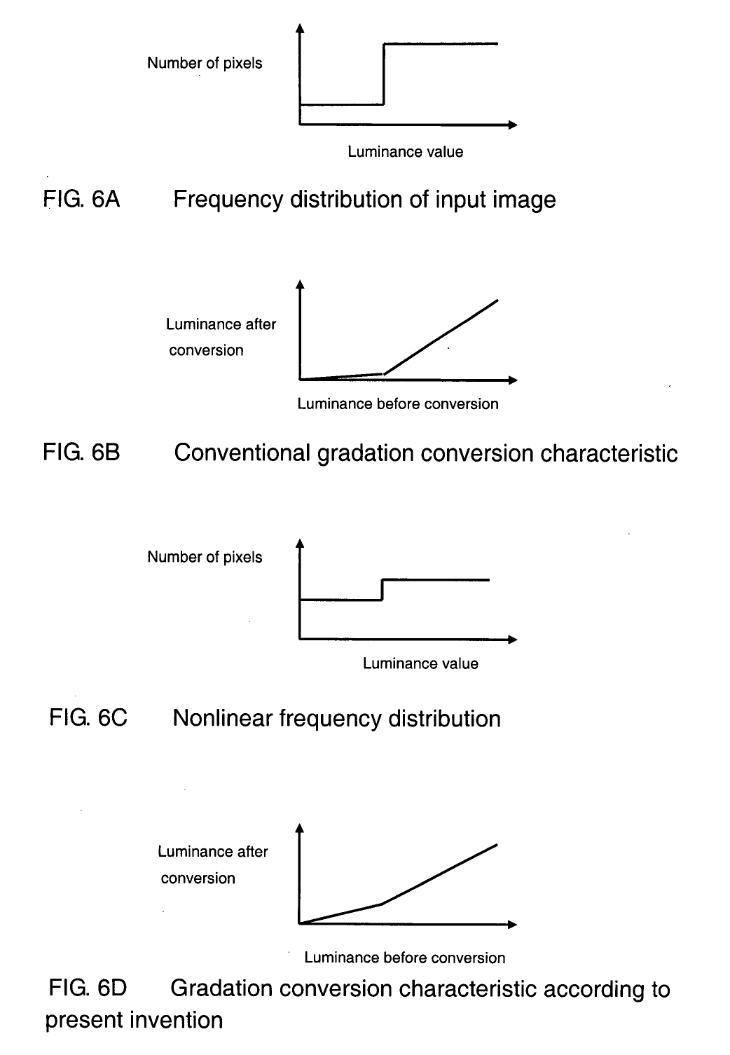

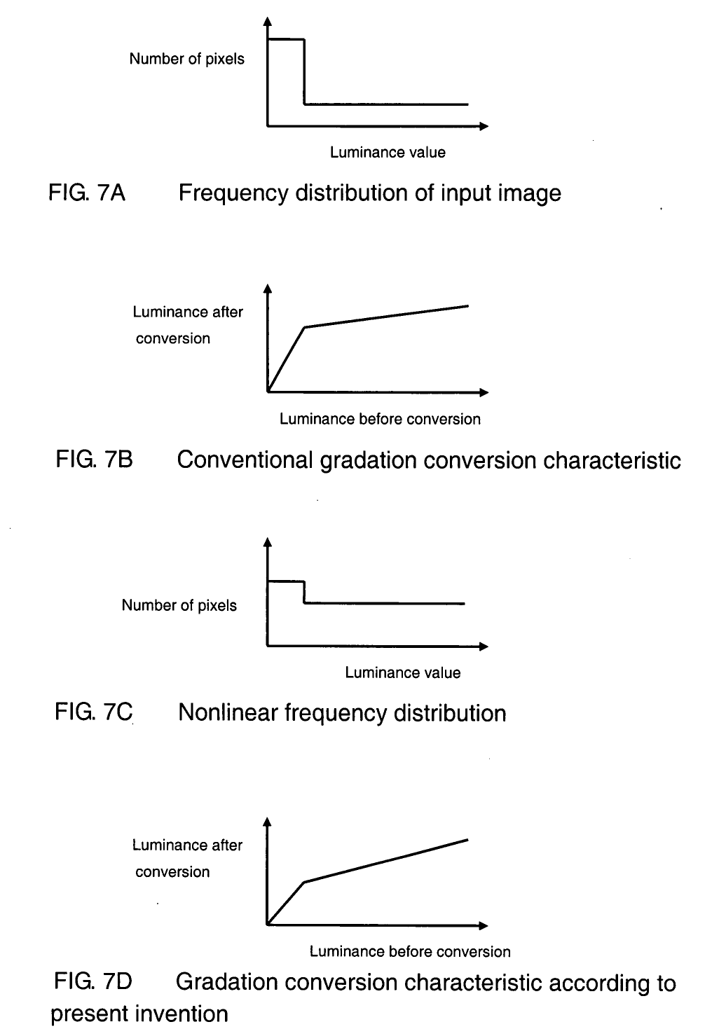

For example, the frequency distribution D(L) shown in FIG. 6A or 7A is converted by the nonlinear converter 5 and then converted into the gentle nonlinear frequency distribution H(L) corresponding to the characteristic of the stimulus in a human brain as shown in FIG. 6C or 7C.

The nonlinear frequency distribution H(L) produced by the nonlinear converter 5 is sent to the accumulation converter 2. The accumulation converter 2 accumulates the nonlinear frequency distribution H(L) for each luminance value L to obtain an accumulated frequency distribution R(L). For example, the accumulated frequency distribution R(0) at a luminance level 0 is set 0 for an initial condition. Then, the nonlinear frequency H(L) at the luminance value L is accumulated from 1 to the maximum luminance value according to Eq. 4 to obtain the accumulated frequency distribution R(L).
R(L)=R(L−1)+H(L) (Eq. 4)

The nonlinear converter 5 normalizes the accumulated frequency distribution R(L) by following Eq. 5 to obtain a gradation conversion characteristic T(L). Here, Lmax denotes a maximum value of the output luminance value L, which is generally equal to a maximum value of the input luminance value. The addition of 0.5 and taking the integer part are to round off the result.
T(L)=int[Lmax×R(L)/R(Lmax)+0.5] (Eq. 5)

For example, the nonlinear frequency distribution H(L) shown in FIG. 6C or 7C is converted by the accumulation converter 2 and then converted into the gentle gradation conversion characteristic T(L) for obtaining a suitable contrast corresponding to a characteristic of stimulus applied to a human brain as shown in FIG. 6D or 7D.

Though the method of performing the accumulation using Eq. 4 by the nonlinear converter 5 and the normalization using Eq. 5 to obtain the gradation conversion characteristic T(L) has been described here, various methods of flattening the frequency distribution have been known up to now. Accordingly any method capable of obtaining the gradation conversion characteristic T(L), which can make the nonlinear frequency distribution of the output image flat, from the nonlinear frequency distribution H(L) can be employed.

As shown in Eq. 6, the gradation converter 3 converts the input image I(X, Y) to obtain an output image O(X, Y) by the help of the gradation conversion characteristic T(L) made within the nonlinear converter 5.
O(X,Y)=T(I(X,Y)) (Eq. 6)

The controller 4 controls the entire status and timing.

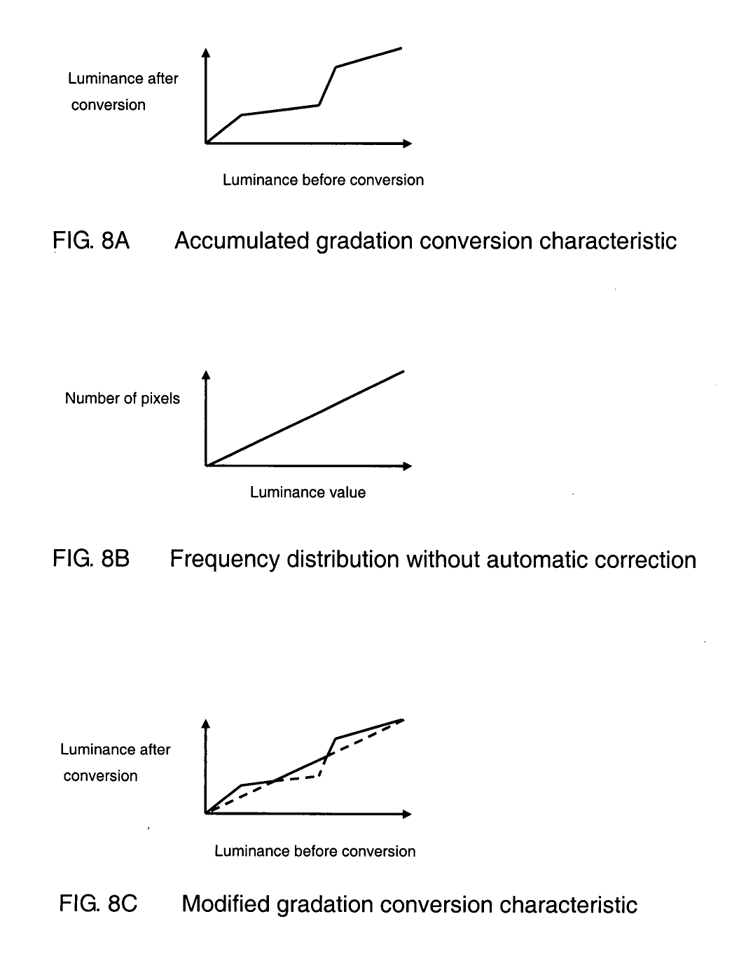

Contrast for human eyes is significantly improved in many cases according to a gradation conversion characteristic for the most effective use of a gradation level range. However, presence of a region which becomes darker after automatic contrast correction than before the correction deteriorates the contrast for human eyes when the view is concentrated to the region. In order to solve such a problem, larger values of the gradation conversion characteristic T(L) as shown in FIG. 8A which is obtained by the accumulation converter and a characteristic as shown in FIG. 8B which is not converted may be selected to correct the gradation conversion characteristic T(L) to a characteristic as shown in FIG. 8C. Alternatively, a non-converted value may be selected when a value becomes smaller after the conversion by the gradation converter.

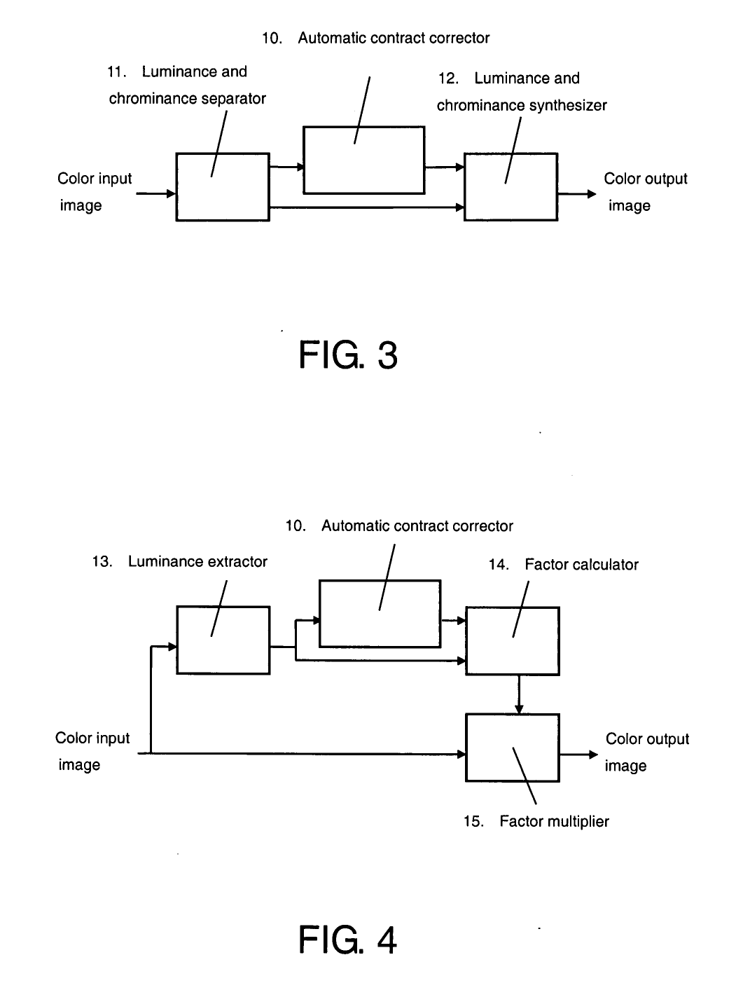

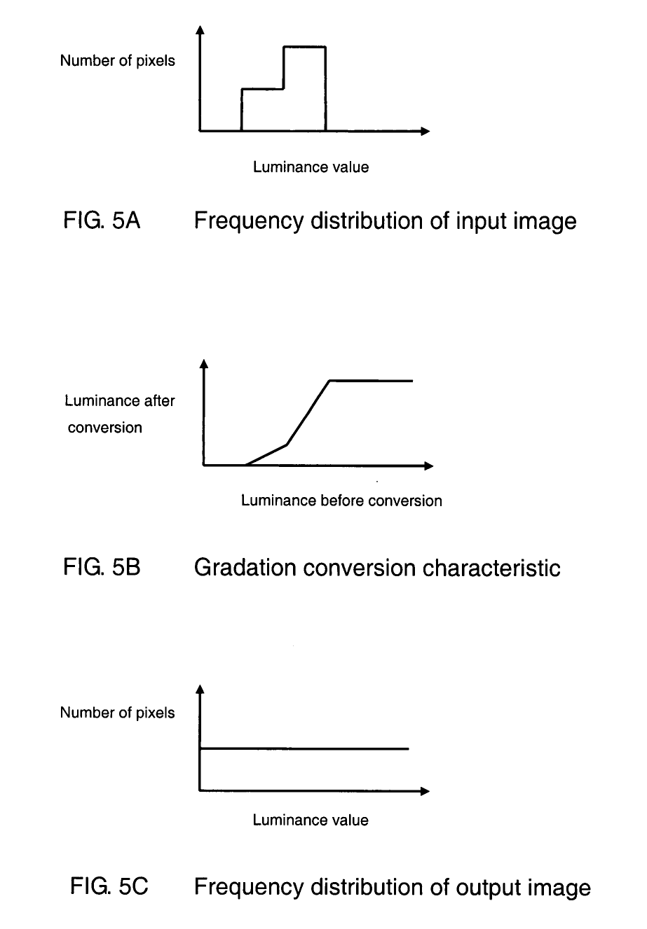

The monochrome image constituted only by luminance signals is described above. However, as shown in FIG. 3 or 4, when the automatic contrast correction method according to the present invention is used for luminance values included in a color image, the present invention can be used for automatic contrast correction of the color image.

In FIG. 3, the luminance values included in color input image are separated by a luminance and chrominance separator 11 and automatically corrected by the automatic contract corrector 10. After that, the corrected luminance values are synthesized by the luminance and chrominance synthesizer 12 to obtain a color output image.

In FIG. 4, a luminance extractor 13 extracts luminance values from a color input image. A factor calculator 14 calculates a factor by which each of the luminance values is multiplied by the automatic contrast correction method. A factor multiplier 15 multiplies the factor calculated by the factor calculator 14 by a value of the same pixel of the original color input image to obtain a color output image. For example, in a case of a color input image in which color information of two-dimensionally arranged pixels are values of three primary colors of red, green, and blue, a contrast of a green value used as the luminance value is corrected by the automatic contrast corrector 10 and a red value and a blue value are multiplied by a value equal to a factor used for automatic contrast correction of the green value. Therefore, the contrast of the color image can be automatically corrected without deterioration of chrominance.

According to the automatic contrast correction device and the automatic contrast correction method of the present invention, an input image can be automatically converted into an image having an excellent contrast to human eyes corresponding to perception of a human brain.

What is claimed is:

1. An automatic contrast correction device for receiving an input image including two-dimensionally arranged luminance information, and automatically correcting a contrast of the input image to generate a corrected output image, comprising:
a frequency distribution counter for obtaining a frequency distribution of the input image for each luminance value thereof;
a nonlinear converter for receiving a frequency distribution from the frequency distribution counter, and converting a frequency for each luminance based on one of a nonlinear function and a nonlinear table to generate a nonlinear frequency distribution;
an accumulation converter for accumulating the nonlinear frequency distribution from the nonlinear converter to generate a gradation conversion characteristic;
a gradation converter for converting the input image based on the gradation conversion characteristic from the accumulation converter; and
a controller for controlling entire status and timing.

2. An automatic contrast correction device according to claim 1, wherein one of the nonlinear function and the nonlinear table for the nonlinear converter comprises one of a function and a table corresponding to a characteristic of a stimulus in a human brain.

3. An automatic contrast correction device according to claim 1, wherein one of the nonlinear function and the nonlinear table for the nonlinear converter comprises one of a logarithmic function and a table produced based on the logarithmic function.

4. An automatic contrast correction device according to claim 1, wherein the one of the nonlinear function and the nonlinear table comprises one of a power function and a table produced based on the power function.

5. An automatic contrast correction device according to claim 4, wherein the nonlinear converter comprises a power function whose exponent is equal to or larger than one fourth and equal to or smaller than one half.

6. An automatic contrast correction device according to claim 1, wherein the gradation conversion characteristic converts the input image to have luminance information such that each pixel has a luminance value not smaller than that of the input image.

7. An automatic contrast correction device according to claim 1, wherein the input image has a linear characteristic.

8. An automatic contrast correction method for receiving an input image including two-dimensionally arranged luminance information, and automatically correcting a contrast of the input image to generate an corrected output image, comprising:
generating a frequency distribution of the input image for each luminance value by counting a number of pixels having a same luminance value;
converting each frequency of the frequency distribution for each luminance based on one of a nonlinear function and a nonlinear table to generate a nonlinear frequency distribution;
accumulating the nonlinear frequency distribution to generate a gradation conversion characteristic; and
converting the input image according to the gradation conversion characteristic.

9. An automatic contrast correction method according to claim 8, wherein the one of a nonlinear function and a nonlinear table comprises one of a function and a table corresponding to a characteristic of a stimulus applied to a person's brain.

10. An automatic contrast correction method according to claim 8, wherein the one of a nonlinear function and a nonlinear table comprises one of a logarithmic function and a table produced based on the logarithmic function.

11. An automatic contrast correction method according to claim 8, wherein the one of a nonlinear function and a nonlinear table comprises one of a power function and a table produced based on the power function as one of the nonlinear function and the nonlinear table.

12. An automatic contrast correction method according to claim 11, wherein the power function has an exponent in a range of equal to or larger than ¼ and equal to or smaller than ½.

13. An automatic contrast correction method according to claim 8, wherein the gradation conversion characteristic converts the input image to have luminance information such that each pixel has a luminance value not smaller than that of the input image.

14. An automatic contrast correction method according to claim 8, wherein the input image has a linear characteristic.
